(19) United States
(12) Patent Application Publication
(10) Pub. No.: US 2005/0063065 A1
(43) Pub. Date: Mar. 24, 2005

(54) Device for reducing or eliminating glare of vehicle headlights

(76) Inventor: John A. Cicale SR., Deptford, NJ (US)

Correspondence Address: Diane Dunn McKay, Esq.;Mathews, Collins, Shepherd & McKay, P.A., Suite 306, 100 Thanet Circle, Princeton, NJ, 08540, US

(21) Appl. No.: 10/939,205

(22) Filed: Sep. 10, 2004

Related U.S. Application Data
(60) Provisional application No. 60/505,537, filed on Sep. 24, 2003.

(51) Int. Cl. B60J 3/00; G02B 27/00; G02B 5/08; G02B 17/00

(52) U.S. Cl. 359/608; 359/601

(57) ABSTRACT

The present invention relates to a device for reducing or eliminating headlight glare from a vehicle in which a shield is expeditiously attached to the inside of a side window. The shield shall be tinted for reducing headlight glare which reflects off of the side view mirror into the driver's eyes through the driver's side window. The device for reducing or eliminating headlight glare has the advantage of being durable, reusable and customizable to a particular shape of the inside side window.

### CROSS REFERENCE TO RELATED APPLICATIONS

This application claims priority of U.S. Provisional Patent Application No. 60/505,537 filed Sep. 24, 2003, entitled Device for Eliminating Glare of Vehicle Headlights, the disclosure of which is hereby incorporated by referenced into this application.

### BACKGROUND OF THE INVENTION

Devices have been described to constrict sun from entering a vehicle. U.S. Pat. No. 4,749,222 describes a sunshade for a vehicle. A sheet of vinyl plastic is applied to the window to electrostatically adhere to the window and act as a sunshield. The sheets are applied to portions of the window through which the sun might otherwise pass to impinge on the vehicle occupant.

During driving at night time, it has been found that the driver can be constantly blinded by the headlights of vehicles behind the vehicle and passing the vehicle on either side. In an effort to solve this problem, drivers have physically held their hand in front of the side view mirror to shield the blinding headlights. This is the shortcoming of strain on the driver and reduction in the safety of the vehicle since the driver is steering the vehicle with only one hand and is not able to utilize the side view mirror. Also, it has been known that drivers redirect the mirror down to eliminate the reflective headlights therefore not being able to utilize the side view mirror.

It is desirable to provide a device for reducing or eliminating headlight glare having expeditious installation.

### SUMMARY OF THE INVENTION

The present invention relates to a device for reducing or eliminating glare from a vehicle headlight in which a shield is expeditiously attached to the inside of the driver's side window. The shield can also be attached to the inside of the passenger's side window. The shield shall be tinted for reducing or eliminating headlight glare which reflects off of the side view mirror into the driver's eyes through the driver's side window or the passenger's side window. The device for reducing or eliminating headlight glare has the advantage of being durable, reusable and customizable to a particular shape of the inside side windows.

The invention will be more fully described by reference to the following drawings.

### BRIEF DESCRIPTION OF THE DRAWINGS

FIG. 1 is a side elevation view of a device for reducing or eliminating headlight glare from a vehicle in accordance with the teachings of the present invention.

FIG. 2 is a side elevational view of an alternate embodiment of a device for reducing or eliminating headlight glare from a vehicle in accordance with the teachings of the present invention.

FIG. 3 is a side elevational view of an alternate embodiment of a device for reducing or eliminating headlight glare from a vehicle in accordance with the teachings of the present invention.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

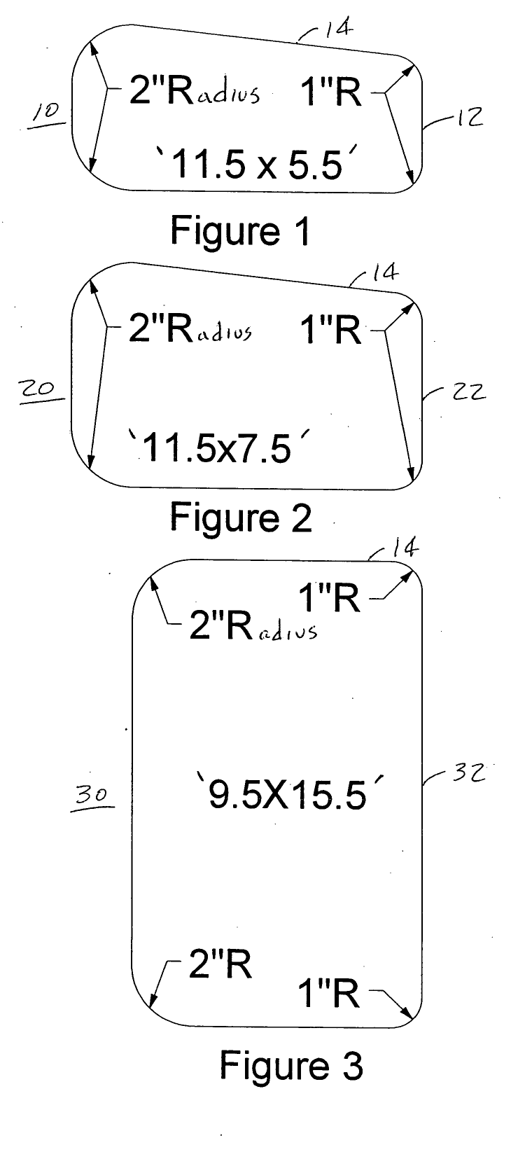

FIG. 1 is a side elevational view of an embodiment of a device 10 for eliminating or reducing headlight glare from a vehicle in accordance with the teachings of the present invention. Device 10 acts as a shield for reducing or eliminating headlight glare which reflects off of the side view mirrors into the driver's eyes. Device 10 includes body 12 having a surface with dimensions to correspond to the dimensions of a driver's side view mirror, passenger's side view mirror or portion thereof. For example, body 12 can have length of about 11.5 inches and a height of about 5.5 inches for corresponding to dimensions of a conventional side view mirror of an automobile, minivan or mini truck. It will be appreciated that the dimensions of body 12 can be selected to correspond to any dimensions of a side view mirror.

In an alternate embodiment, device 20 is shown in FIG. 2. Device 20 acts as a shield for reducing or eliminating headlight glare from a vehicle. Device 20 includes body 22 having a surface with dimensions to correspond to dimensions of a driver's side view mirror, passenger's side view mirror or a portion thereof. For example, body 22 can have a length of about 11.5 inches and a height of about 7.5 inches corresponding to dimensions of a conventional side view mirror of full size Sports Utility Vehicles (SUV), vans or trucks. It will be appreciated that the dimensions of body 22 can be selected to correspond to any dimensions of a side view mirror.

In an alternate embodiment, device 30 acts as a shield for reducing or eliminating headlight glare from a vehicle is shown in FIG. 3. Device 30 includes body 32 having a surface with dimensions to correspond to dimensions of a tractor trailer cab, commercial truck or van, or bus side view mirror or a portion thereof. For example, body 32 can have a length of about 9.5 inches and a height of about 15.5 inches corresponding to dimensions of a tractor trailer cab, commercial truck or van, or bus side view mirror. It will be appreciated that the dimensions of body 32 can be selected to correspond to any dimensions used in the inside tractor trailer cab, commercial truck or van, or bus side view mirror.

Devices 10, 20, and 30 are formed of material 14 which can be a vinyl material having one or more layers. For example material 14 can be formed of a patio-grade film having a thickness of about 0.010 inches. Material 14 can include color therein for providing a tinted material. For example, material 14 can have a charcoal color. Material 14 shall have cling properties for clinging devices 10, 20 or 30 to a respective driver's side window, for example, electrostatic properties.

A pair of devices 10, 20 or 30 can be removably attached to an inside surface of a driver's side window and an inside surface of a passenger's side window.

It is to be understood that the above-described embodiments are illustrative of only a few of the many possible specific embodiments which can represent applications of the principles of the invention. Numerous and varied other arrangements can be readily devised in accordance with these principles by those skilled in the art without departing from the spirit and scope of the invention.

1. A device for reducing or eliminating glare of vehicle headlights comprising:
said device removably attached to an inside surface of a side window of a vehicle, said device having a body with dimensions corresponding to said side window, and said device being formed of a material for reducing or eliminating light from headlights of a vehicle.

2. The device of claim 1 wherein said material is formed of a vinyl material having one or more layers.

3. The device of claim 1 wherein said material further comprises a color for tinting said material.

4. The device of claim 3 wherein said color is charcoal.

5. The device of claim 1 wherein said material electrostatically engages said side window.

6. The device of claim 1 wherein said body has a length of about 11.5 inches and a height of about 5.5 inches for corresponding to dimensions of side view mirrors of an automobile, minivan or truck.

7. The device of claim 1 wherein said body has a length of about 11.5 inches and a height of about 7.5 inches corresponding to dimensions of side view mirrors of full size Sport Utility Vehicles, vans or pick-up trucks.

8. The device of claim 1 wherein said body has a length of about 9.5 inches and a height of about 15.5 inches corresponding to dimensions of a tractor trailer cab, commercial truck or van, or bus side view mirror.

9. The device of claim 1 comprising a pair of said devices removably attached to an inside surface of a driver's side window and an inside surface of a passenger's side window.
